(19) United States
(12) Patent Application Publication
(10) Pub. No.: US 2021/0007925 A1
(43) Pub. Date: Jan. 14, 2021

(54) EXERCISING, MOBILITY TRANSPORTER APPARATUS AND METHOD

(71) Applicant: Phillip Miller, Laramie, WY (US)

(72) Inventor: Phillip Miller, Laramie, WY (US)

(21) Appl. No.: 16/920,626

(22) Filed: Jul. 3, 2020

Related U.S. Application Data
(60) Provisional application No. 62/870,368, filed on Jul. 3, 2019.

(51) Int. Cl. A61H 3/04; A63B 23/02; A63B 21/00; A61G 5/14; A61G 5/04

(52) U.S. Cl. CPC A61H 3/04; A63B 23/0211; A63B 21/4015; A61H 2201/1635; A61G 5/04; A61H 2003/043; A63B 2208/0204; A61G 5/14

(57) ABSTRACT

An exercise and standing transport unit includes a base, superstructure, motor, wheels, power source, and controller operably connected to carry a user, in a standing posture. From a sitting position on any furniture a user may pullup a standing posture on the base (surrounded by support forward, backward, and on each side) and then move at will along a support surface powered by the motor, and controlled through the controller forward, backward, and pivoting about a vertical axis. A user is thereby free to exercise upper body, lower body, and core, including muscles, bones, and tendons, even through daily living activities, thus maintaining mass and motivation for compliance, and circulation by movement to resist compression sores.

### RELATED APPLICATIONS

This application claims the benefit of co-pending U.S. Provisional Patent Application Ser. No. 62/870,368, filed Jul. 3, 2019, which is hereby incorporated herein by reference in its entirety.

### BACKGROUND

### Field of the Invention

This invention relates to exercise and, more particularly, to novel systems and methods for providing exercise opportunities in a standing-posture transporter providing mobility and lifestyle activity improvements for partially-invalid (physically restricted, injured, or debilitated) patients.

Wheelchairs have been known for centuries. Motorized wheelchairs are a more recent development. Invalids who cannot move or do not move develop physical difficulties as a consequence of their immobility and inability to exercise. Persons unable to move themselves, or to exercise, are susceptible to a host of health ills unrelated to their invalid condition, but rather to their immobility.

Meanwhile, providing mobility is fraught with various problems of itself. For example, many activities range from inconvenient to simply not possible from a sitting position, including many kitchen tasks at a conventional counter or table. Likewise, from a sitting position, very few exercises can be performed.

Moreover, lifestyle activities such as taking care of oneself, going to a refrigerator, preparing a meal, washing dishes, getting out of bed and the like can all be problematic depending on exactly the mobility problem is for a particular subject.

It would be an advance in the art to create an exercise device that also operates as a transporter to keep active a person who may be partially immobilized. One may thus be capable of lifestyle activities, and also changing position regularly while maintaining weighting on feet, legs, muscles, core, arms, and hands.

Moreover, it would be a significant advance in the art to provide patient compliance with exercise regimens by providing an apparatus and method that permit lifestyle activities or daily living activities by positioning a user for maximum freedom of motion, with a natural motivation of daily life activities as both exercise and as motivation to perform actions that exercise bodily members regularly.

### BRIEF SUMMARY OF THE INVENTION

In view of the foregoing, in accordance with the invention as embodied and broadly described herein, a method and apparatus are disclosed in one embodiment of the present invention as including a frame made of a base with a super structure thereabove having a drive system in which a motor or motors will drive to move the frame about. A control system connected to the frame, and particularly this super structure controls the drive wheels through the drive system motors. By castering other wheels, the drive wheels will literally rotate the apparatus on a dime by moving the drive wheels independently with the casters simply following as force vectors may direct.

A user is provided a deck for standing, rather than a seat for sitting. However, the deck is suitably supported at a comparatively low height within the envelope (space allocation) of the base such that the user is not elevated very far above a supporting surface such as a floor.

Thus, a user is standing close to the floor and thus remains with a center of mass or a center of gravity about the same as if standing on the supporting surface (floor). In certain embodiments, suitable cross bracing low in the frame, such as on or within the base may support a power supply such as heavy batteries, thus further stabilizing the apparatus. From the base, risers extend upward forming part of the super structure, and at the tops thereof may actually support stringers directed forward and backward from the risers in order to provide support for handles forward of a standing user, and to provide for lateral guides and restraints on each side (left and right) of the user. A forward restraint provides restraint against falling or being thrust too far forward. The forward restraint typically will operate against thighs of a user, although it may be as high as the waist.

However, being able to move the torso at the waist and about the hips is an important mechanism for exercising by a user. However, this functionality may be tailored toward a specific user. Handles may constitute a forward handle for reaching that provides the necessary leverage and positioning for a user to mount the apparatus. However, a rearward restraint preventing the rider or user from advancing too far forward, in other words, restraining the user to stay rearward of that restraint, may actually be in contact with the thighs or waist of a user.

Since an apparatus in accordance with the invention provides daily life activities exercise device and compliance with a regimen, the rearward restraint that holds the rider or user rearward will contact the thighs or waist, in order to provide as much hip motion and core body motion of the torso possible.

For example, being able to turn, twist, bend, and so forth, provides an excellent source of exercise for both the core muscles in the torso and muscles in and about the legs. Meanwhile, being able to pivot at the waist in every direction provides exercise of core muscles of the body but also provides positioning in order to use upper body muscles in the arms, shoulders, hands, forearms, and so forth.

Thus, an apparatus and method in accordance with the invention provide protection by way of restraint against moving too far forward by restraining the user rearward. Also, a handle forward of that restraint operates as a reach bar or reach handle to aid in mounting, and for comfortable resting of hands or holding onto the apparatus at a location comfortable and providing a more effective geometry and leverage. Thighs or waist may be held rearward or sustained rearwardly and prevented from moving forward, but that rearward restraint is not positioned for effective leverage.

In like manner, but with a very different mechanism, a forward restraint restraining the user toward a forward direction and resisting movement backward may be configured in multiple parts that pivot from a stowed position parallel to the stringers and secured to a location proximate the back end of the stringers. This set of forward restraints may thus pivot into position rotating about a non-orthogonal axis with respect to the stringers in order to pivot from a vertical position or orientation parallel to the stringers to pivot around behind the stringers in which they change orientation ninety degrees by motion along the forty degree plane.

Thus, these forward restraints, which may contain pads, may provide a quasi-sitting ability. Vertical support is actually minimized and not total, but nevertheless provides support and resting to maintain a standing posture throughout extended periods of time.

A user relying on an apparatus in accordance with the invention thus has an ability to move about, including translating forward, translating backward, and pivoting about any center of rotation. A center of rotation may locate within the apparatus, such as a vertical axis directly between the wheels and through their centers of rotation. Or any vertical axis within the apparatus.

Likewise, by accommodation of translation forward or backward, and gradual rotation, an arc may be scribed by the path of an apparatus in accordance with the invention effectively at any radius in any direction desired.

The ultimate result is the exercise that comes directly not from some artificial regimen but from daily living activities that require and therefore exercise support by the feet, support by the legs, motion of the feet and legs, movement of the body generally, thereby negating any constant-pressure-induced, circulation difficulties that might otherwise occur.

Likewise, the core muscles in the thighs, buttocks, abdomen, and chest of a user, as well as the back, shoulders, arms, forearms, and so forth are all exercised and are all put in positions to be exercised through daily living activities (DLA).

A unit may comprise a base, superstructure, motor, wheels, power source, and controller operably connected to carry a user, weighting the feet of the user in a standing posture, the base defining a longitudinal direction forward and backward, a lateral direction left and right, and a transverse direction vertically, all mutually orthogonal. A user may arise from a sitting position on furniture to the standing posture on the base and within an enclosed (fenced) region. Moving the user, in a standing posture, the device (unit) will travel along a supporting surface in response to the user operating the wheels, powered by the motor, through the controller.

The superstructure may be provided with a forward support, and use may include positioning the forward support behind the user to limit movement of the user backward with respect to the unit. Moving may include translating forward, translating backward, and pivoting about a vertical axis positioned at an arbitrary location with respect to the unit. The forward restraint (support) is shaped and positioned with respect to the unit and the user to provide a degree of vertical support to the user while maintaining the majority of the weighting on the feet. At least one handle is positioned forward of the user and lateral supports positioned are left and right thereof, together defining the enclosed space. That the enclosure leaves the user free to exercise core muscles by bending left, right, backward, and forward from the waist.

By positioning the unit near furniture gripping, by the user, the superstructure forward of the enclosed region enables pulling, the body of the user into the standing posture on the deck. The furniture may be a bed, couch, chair, wheelchair, or motorized seat.

Positioning typically includes moving a proximal end of the base to fit in a lapping relation with the furniture in a floor space shared by both. This may include fitting under, between, or around legs or lowest members of the furniture.

Exercise includes moving forward, backward, left, and right to accomplish tasks using the hands of the user outside the enclosure. Two drive motors, each independently controllable, drive wheels spaced to stabilize the base on a flat underlying surface. The drive wheels may be operably connected to each be driven by a respective one of the two drive motors to rotate proximate a front, distal, end of the base. Casters are best positioned at a proximal end of the frame to rotate on a horizontal axis and pivot about a vertical axis in response to a difference in a rate of rotation between the drive wheels. The base is provided with a deck to support comfortably the feet of the user. A front brace stabilizes the legs of the user against moving too far forward with respect to the deck.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1A is a frontal perspective view of an apparatus in accordance with the invention for exercise and movement of a standing user in accordance with the invention;

FIG. 1B is a frontal perspective view of an alternative embodiment of an apparatus in accordance with the invention;

FIG. 2A is a rear perspective view of the apparatus of FIG. 1A;

FIG. 2B is a rear perspective view of the apparatus of FIG. 1B;

FIG. 3 is a front elevation view of the apparatus of FIG. 1A;

FIG. 4 is a right side elevation view thereof;

FIG. 5 is a rear elevation view thereof;

FIG. 6 is a left side elevation view thereof;

FIG. 7A is a top plan view thereof;

FIG. 7B is a top plan view thereof with the forward restraints deployed instead of stowed as in FIG. 7A;

FIG. 8A is a bottom plan view of an apparatus in accordance with the invention;

FIG. 8B is a bottom plan view thereof with the forward restraints deployed rather than stowed;

FIG. 9 is a frontal perspective view of an apparatus in accordance with the invention having the body or cover portions removed to show the power supply in relation to the frame and drive wheels;

FIG. 10 is a side elevation view of the beginning of a transition of a user from a motorized wheelchair into the apparatus;

FIG. 11 is a side elevation view thereof with a user having moved from a motorized wheelchair into an apparatus in accordance with the invention;

FIG. 12 is a side elevation view thereof during stabilization using handles on the frame of an apparatus in accordance with the invention, while moving the forward restraints from a deployed position from a stowed position to a deployed position;

FIG. 13 is a side elevation view of an apparatus in accordance with the invention having a user in a standing posture thereon;

FIG. 14 is a rear elevation view thereof;

FIG. 15 is a side elevation view of the forward restraint in a deployed position;

FIG. 16 is a side elevation view of the forward restraint in a partially deployed position;

FIG. 17 is a side elevation view of one forward restraint in a fully deployed position with a second forward restraint in a partially deployed position; and

FIG. 18 is a side elevation view of an apparatus in accordance with the invention having both forward restraints in their fully deployed positions.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of systems and methods in accordance with the invention. The illustrated embodiments will be best understood by reference to the drawings, wherein like parts are designated by like numerals throughout.

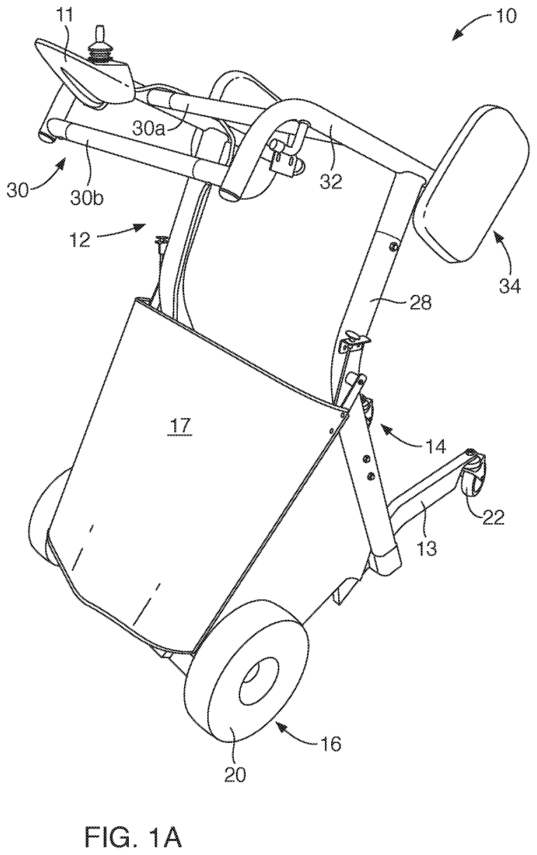

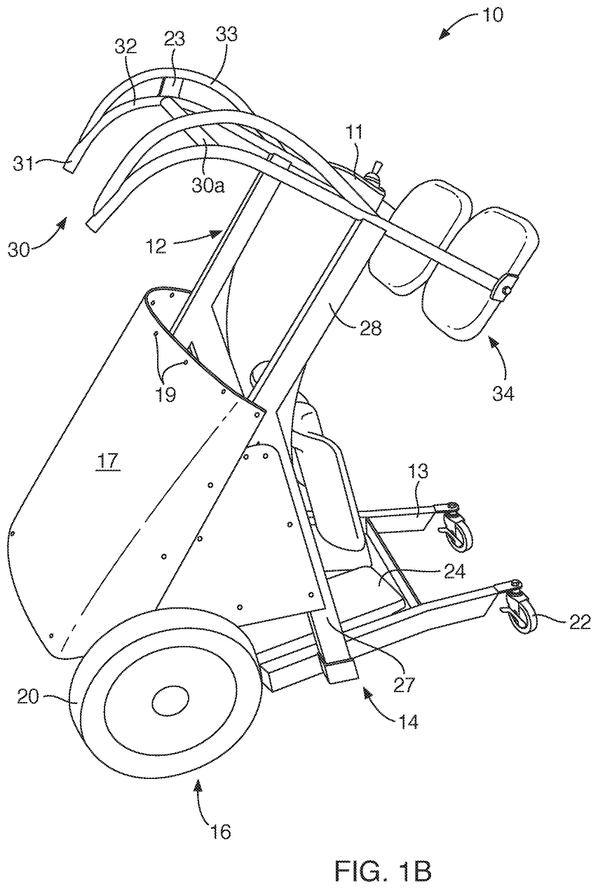

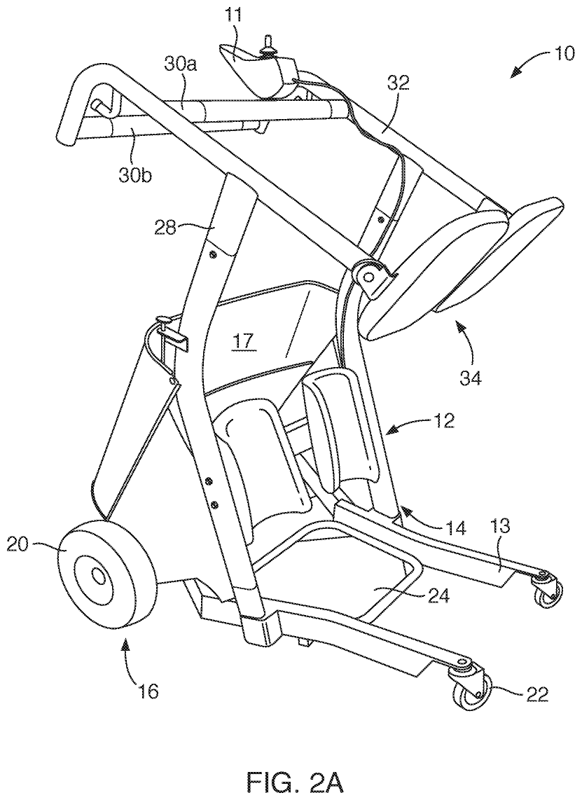

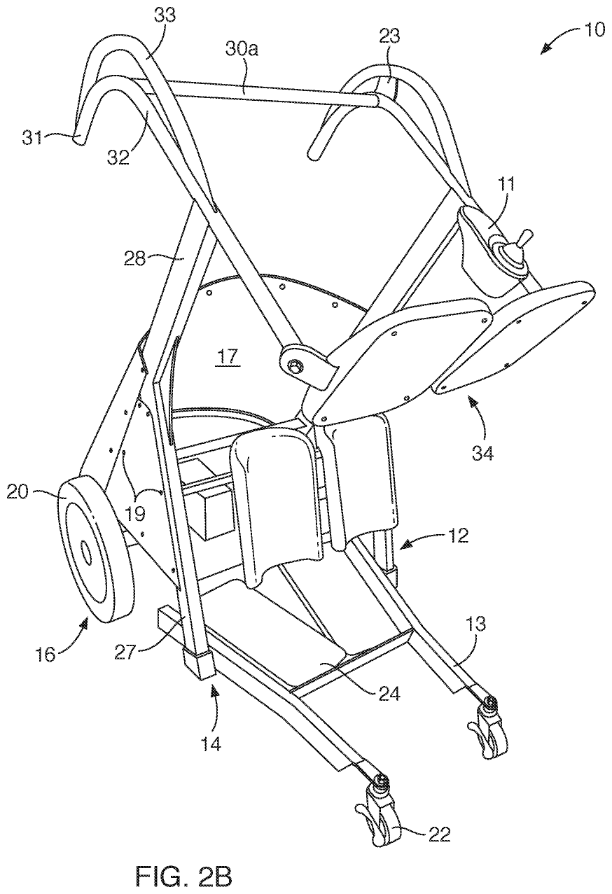

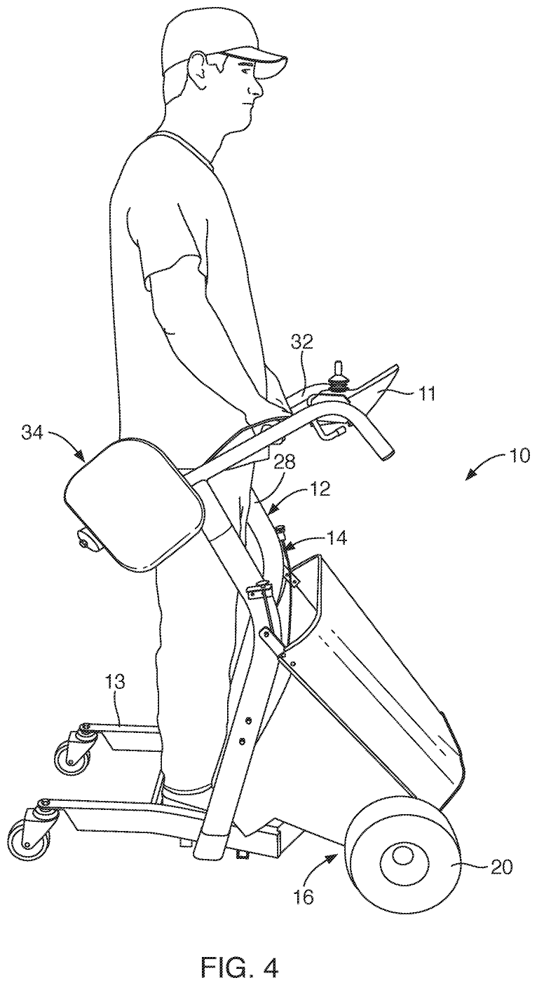

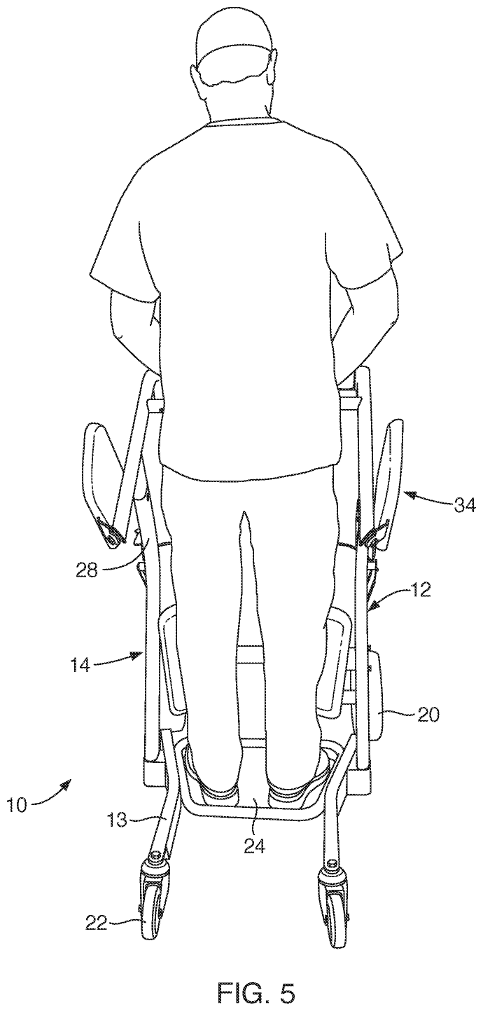

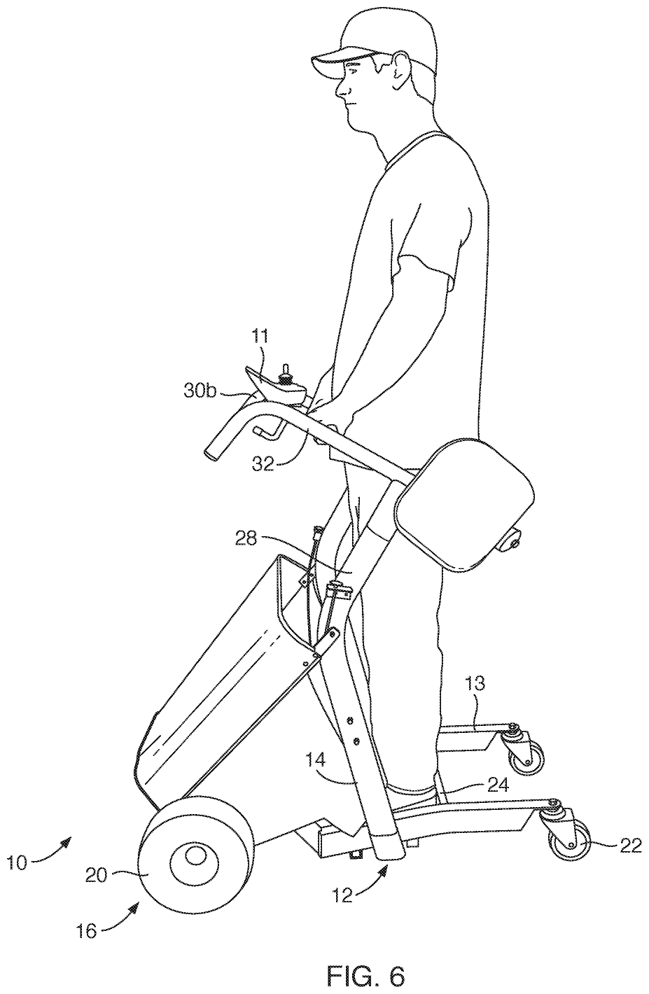

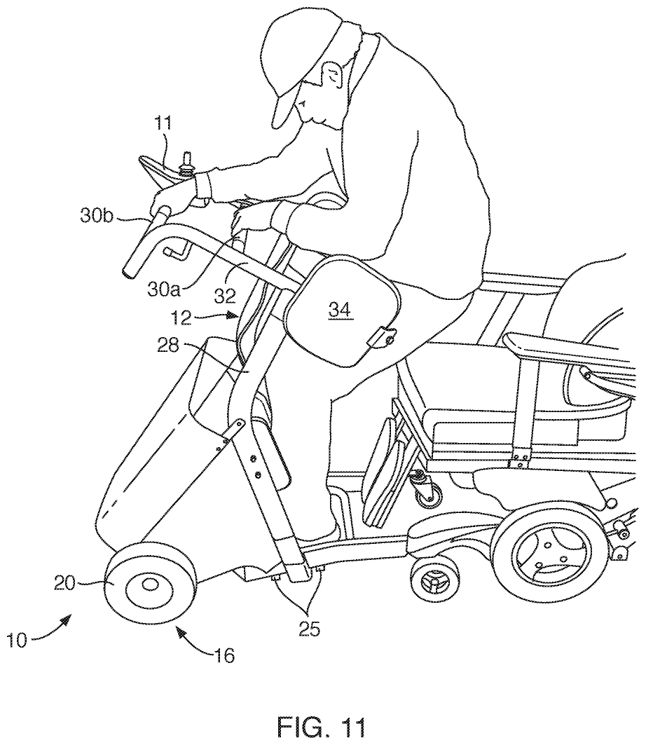

Referring to FIGS. 1A, 1B, 2A and 2B, while continuing to refer generally to FIGS. 1A and 1B through 18, an apparatus in accordance with the invention will typically include a control system 11 mounted to a frame 12 in order to be accessible to a user 15. The frame 12 is typically comprised of a base 13 near a supporting surface such as a floor, deck, sidewalk, street or the like.

In many embodiments, the underlying surface is the floor of a home. One of the benefits provided by an apparatus and method in accordance with the invention is the ability to rely on daily living activities (DLA) as a source and a motivation for exercise by a user 15 or patient 15.

Compliance difficulties can defeat the very best physical therapy regimen or exercise program. Thus, an apparatus and method in accordance with the invention may rely on daily living activities as both the motivation and the exercise. Independence is extremely important and valuable to persons who are partially immobilized and such a combination as included in the apparatus and method of the invention provide myriad benefits thereby.

In general, the base 13 has a portion of the frame 12 supports a super structure 14 extending thereabove. A drive system 16 will typically include motors 18 and wheels 20 or drive wheels 20 as well as casters 22 that are simply “idlers.” For example, the drive wheels 20 rotate to move the apparatus 10 forward or backward. The drive motors 18 are independently controllable by the control system 11 in order that each may travel at its own speed in a forward direction or backward direction, and each may do any such rotation independently from the other.

Accordingly, the apparatus 10 can literally turn on a dime rotating a left drive wheel 20 in an opposite direction from a right drive wheel 20 will literally rotate the apparatus 10 about a vertical axis through the line between the axis of rotation of the drive wheels 20. Meanwhile, the casters 22 simply move as driven by the base 13 rigidly connecting the mounts of the drive wheels 20 to the mounts of the wheels 22 (casters 22).

With respect to FIGS. 1B and 2B, an alternative embodiment provides certain distinctions. For example, steering is made easier, and requires less power by reducing the distance between the wheels 20 and the casters 22. The risers 28 extend to the front of the cowling 17, rather than down to the base 13. Instead, a diagonal 27 extends from the riser 28 down to the base 13.

This provides a triangulation in the frame 12, rather than depending so heavily on the riser 28 for strength and stiffness. For example, the fasteners (e.g., rivets, screws, etc.) secure the cowling 17 pieces to the riser 28, diagonal 27, and a horizontal frame member therebetween. The horizontal row of fasteners 19 at the bottom of the cowling 17 and just above the base 13 (as well as those elsewhere) anchor the cowling 17 to the frame 12.

Similarly, the upper bars 33 connecting to each of the stringers 32 provide at least two benefits. First, vertical structural strength and stiffness increase dramatically, while side-too-side strength and stiffness double in the illustrated embodiment. Second, the upper bar 33 or stiffener also provides increased height to pull against when loading or unloading a rider, without changing access to the handles 31 at the end of the stringers 32, 33. Thus, the reach bar 30b or front crossbar 30b need not remain as an obstruction. Any useful function provided by it may be provided by the handles 31.

By removing the cross bar 30b, a user can still use the handles 31 to pull forward for loading, unloading, or otherwise standing away from the pads 36 of the forward restraint 34. Also, an assistant or attendant has the handles 31 to move the apparatus 10 in any rolling direction, with or without a rider standing on the deck 24. Having a disengagement mechanism between a motor 18 and its corresponding wheel 20 may ease resistance to motion. Such disengagement mechanism may be mechanical, electrical, or fluid-based. Such a clutch or connector selectively engages and disengages the motors 18. Many suitable mechanisms may be implemented. Thus, the system 10 may be operated by a rider or an attendant.

Additionally, a plate 23 between the bars 32, 33 is stably mounted to support the controller 11 in a higher, more forward position. In the illustrated embodiment of FIGS. 1B and 2B, the controller 11 is positioned lower and rearward to be easily accessible with no need to reach upward and forward.

This arrangement stiffens the frame 12, which also includes gusseting between the riser 28 and diagonal 27, as well as similar framing under (hidden by) the cowling. For example, beams across (left to right, etc.), pillars vertical, and diagonal bracing are include as appropriate in order to strengthen and stiffen.

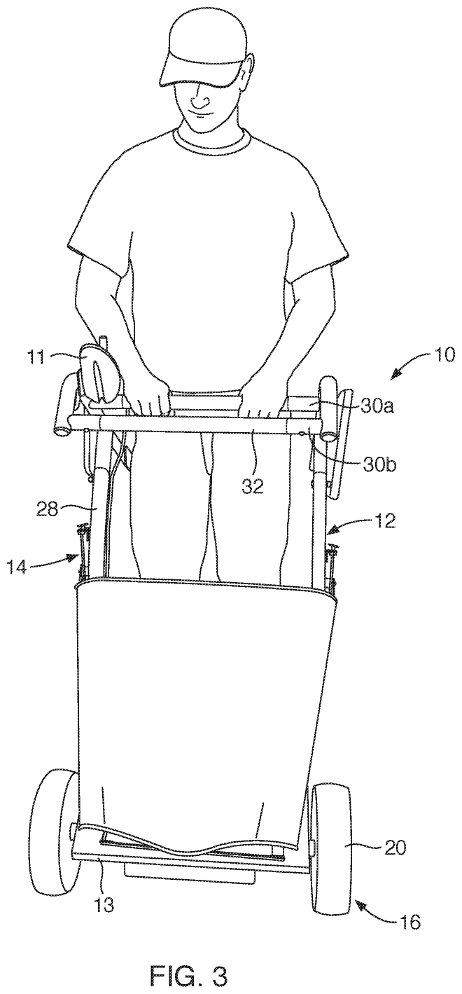

Referring to FIGS. 3 through 9, while continuing to refer to FIGS. 1A, 1B, 2A and 2B, as well as FIGS. 1A through 17 generally, a deck 24 may be mounted to be comparatively close to the floor or underlying surface. This will maintain the center of gravity of the entire apparatus 10 with a user 15 thereon as close to the underlying surface as reasonable. This resists tipping of the apparatus 10, important for users of limited mobility. Supports 25 underlying the deck 24 extend across and under the base 13. Padding may ease pressure on feet. For example, around a home, a user 15 may not necessarily require shoes. Accordingly, the deck 24 may be padded in order to be suitable for bare feet, stocking feet, bedroom slippers, or the like while distributing pressure across the bottom of a foot and not creating excessive pressure. Pressure on feet may be important to maintaining a user's ability to remain in a standing posture on the deck 24 of an apparatus 10 for extended periods of time.

Cross bracing 26 may be provided in one of several suitable ways and is up to the structural design of an individual engineer who may simply need to support the weight and forces arising from the weight, size, and so forth of a user 15 on an apparatus 10.

One will note that the risers 28 rise from the base 13, but struts may be used to brace risers 28. On the other hand, in certain embodiments, the risers 28 may simply have an increased cross-sectional area, thereby self-stabilizing, even at their connecting welds or other fastenings where the risers 28 contact the base 13 of the frame 12.

Of significant utility to a user are handles 30. For example, a handle 30a operates as a rearward restraint 30a. That is, a restraint toward the rear direction, resisting shifting or falling forward. Thus, the handle 30a provides contact with a torso, waist, or thighs of a user 15. In certain embodiments, the user 15 may maintain a posture somewhat away from the rearward restraint. In other situations, a user 15 may rest against the rearward restraint 30a.

Typically, the reach handle 30b is positioned ahead of and below the handle 30a. In this way, a user 15 may rely on the handles 30a, 30b together in order to provide a comfortable location, needed leverage, and stability in mounting the apparatus 10.

One will note that the handles 30a, 30b need support, provided by a pair of stringers 32 acting as braces 32 or lateral guides 32. The stringers 32 extend along from a position beside a standing user 15 forward of the user 15. Thus, one will note that a user 15 is provided bracing or support by the stringers 32 in a lateral (side-to-side) direction.

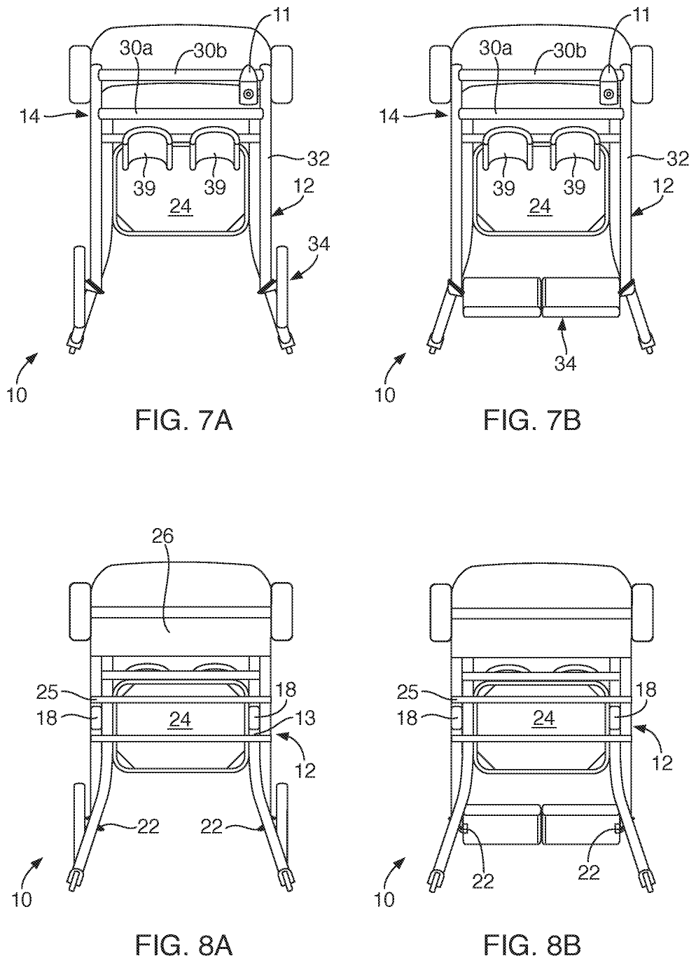

Referring to FIGS. 7A through 8B, while continuing to refer generally to FIGS. 1A and 1B through 18, the forwards restraints 34 may secure to the stringers 32 at their rearward ends thereof. For example, an ear 35a extending on one side of a pad 36 or a frame underlying a pad 36 constituting a restraint 34 may engage a pivot 35b secured to the stringer 32 at the rearward end thereof, and permitting pivoting of the ear 35a and therefore the restraint 34 and pad 36 about that pivot 35b.

To that end, the angled end 35c provided at the rearward end 35c of the stringer 32 operates on a canted or angled position at effectively 45 degrees between an orthogonal forward direction and sideways direction. Accordingly, the pad 36 when pivoted about the pivot 35b will move outwardly to a fixed position at which it stops parallel to a stringer 32.

Meanwhile, the deployment of a forward restraint 34 and pad 36 is a simple matter of pivoting the pad 36 and ear 35a upward and inward toward the vertical center plane of the apparatus 10. As the ear 35a and pad 36 pivot inwardly and upwardly about the pivot 35b, in a plane of rotation that is effectively coincident of the angled end 35c of the stringer 32, the ear 35a pivots to a deployment stop that fixes the position of the pad 36 in a plane extending across between the stringers 32.

Thus, a user 15 can lean back against the pads 36, which are inherently stable because their stop on the ears 35a resist any further downward or rotational motion inward by the pads 36.

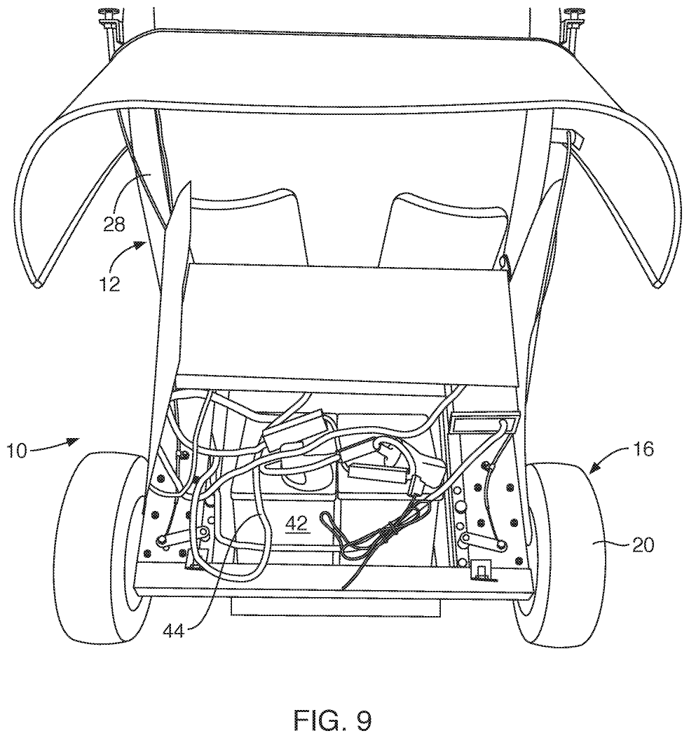

Referring to FIG. 9, the body 38 or cover 38 provides contouring, decoration, and obscuration for the power supply 42. Connections 44 from the power supply 42 to the motors 18 are controlled by the control system 11. Various buttons, levers, joysticks, and so forth in the control system 11 provide access with finger or other touch controls by a user 15 into the control system 11. The control system 11 may then operate relays that carry the principal power and electrical current from the power supply 42 to the motors 18 engaging and powering the motors to move forward, or to halt. A brake system may be provided to automatically brake the motors 18, or the drive wheels 20 whenever the control is in a position indicating a stopped condition.

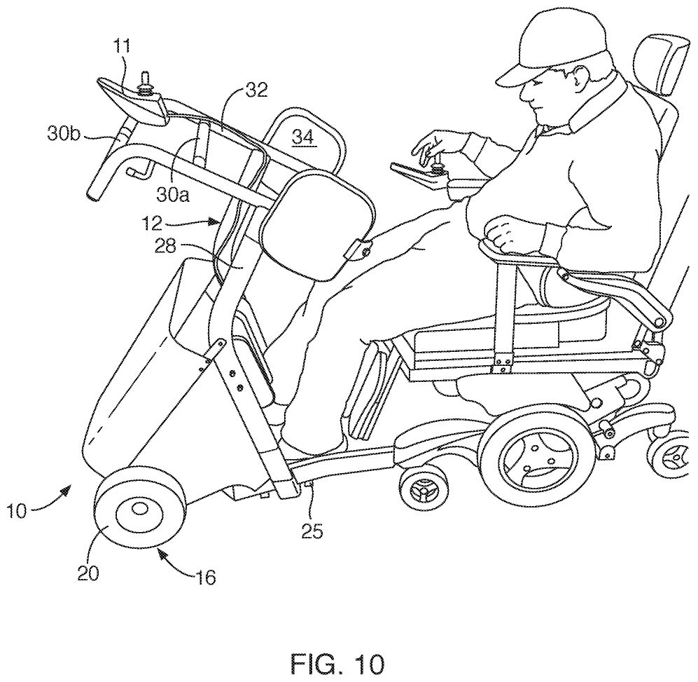

Referring to FIGS. 10 through 14, while continuing to refer generally to FIGS. 1A and 1B through 18, transition in operation of the apparatus 10 are illustrated. For example, in FIG. 10, one may see a motorized wheelchair 50 approaching and engaging by overlapping a portion of the base 13 of the apparatus 10. A user 15 may retreat or stow the foot pads from the motorized wheelchair and position the wheelchair 50 to straddle the base 13 of the frame 12 by the structure of the wheelchair 50.

Likewise, in rising from a kitchen chair, a couch or armchair, a bed, bench, or the like, the base 13 provides a user 15 with clearance thereabove at the rear end of the apparatus 10 in order to project the base 13 any necessary distance under the furniture 50 exemplified by the motorized wheelchair 50. The user may place feet on the deck 24 and grasp either or both of the handles 30a, 30b. Using the handles 30a, 30b, the user 15 may rise from the furniture to a standing posture, whatever posture that is for an individual user 15. In the illustrated embodiment, both handles 30a, 30b and both hands of a user 15 are available to stabilize a user 15.

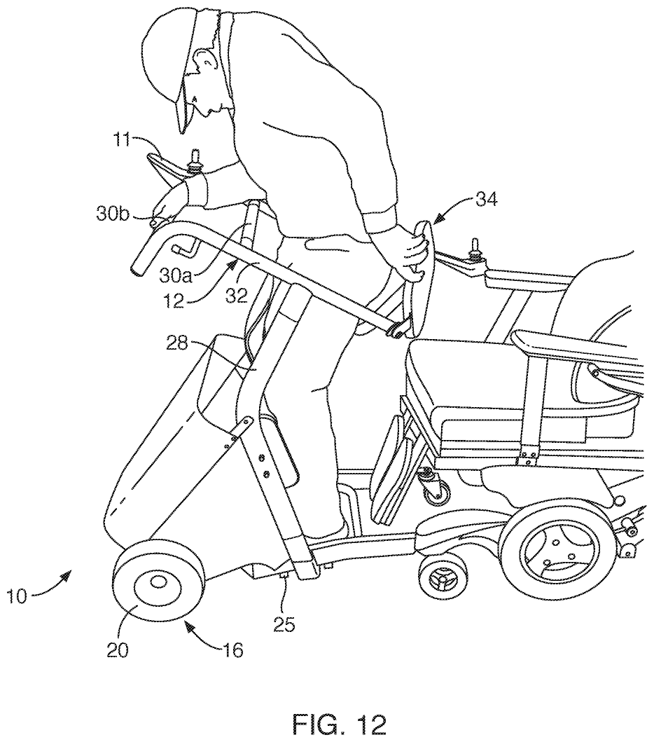

Referring to FIG. 12, one will note that one hand of a user 15 may still be applied to one of the handles 30, while permitting the other hand to access the forward restraints 34. In the illustrated embodiment, the reach handle 30b is significantly ahead of and below the restraint handle 30a, thereby providing extra reach for a user 15 to move forward over the restraint handle 30a, while remaining stabilized by that restraint handle 30a.

Upon deployment of each of the pads 36 in turn, the forward restraint 34 is fully deployed and a user 15 may actually apply force against the forward restraint 34.

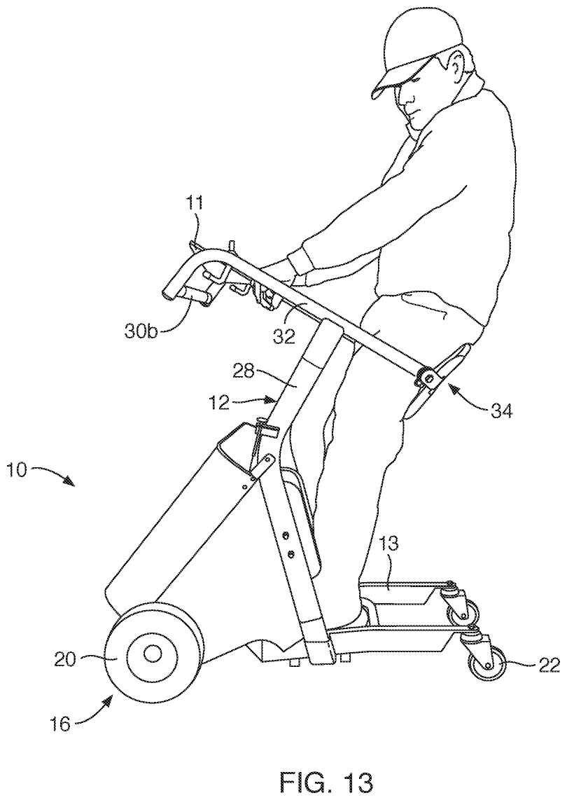

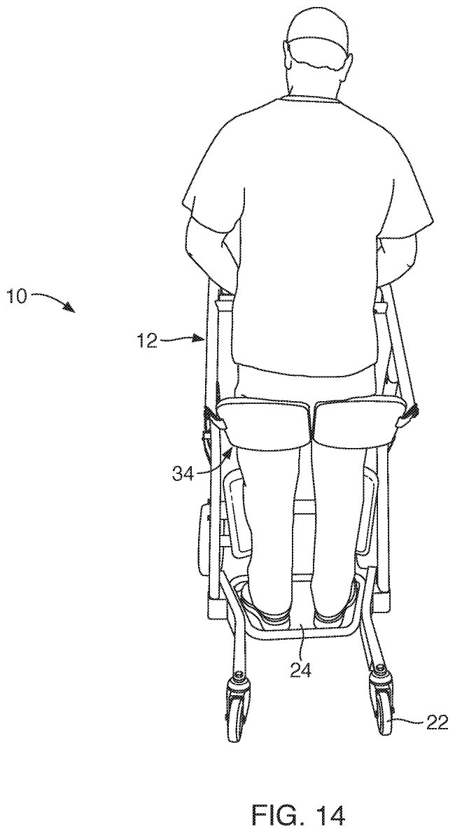

Referring to FIGS. 13 and 14, while continuing to refer generally to FIGS. 1A and 1B through 18, one will immediately note that by proper positioning, the forward restraint 34 may actually provide a certain degree of support in combination with the feet to support a certain amount of the torso weight or upper body weight of the user 15 in a vertical direction.

However, one will also note that the position of the stringers 32 is such that a user 15 is now supported in every necessary direction for use of musculature in the lower body and upper body and especially in all the core muscles near the abdomen, hips, and thighs by moving in any desired direction. For example, from the standing posture in an apparatus 10 in accordance with the invention, a user 15 may lean to the right or left against a stringer 32, while also grasping either of the handles 30 with the opposite hand. Also, for example, a user 15 may direct the apparatus 10 up to a counter containing a sink, rotate the apparatus 10 in order to put a right or left side of the user 15 against the counter, and may then lean over the counter to operate in the sink using one or both hands. A user 15 may lean against a stringer 32 and use both hands at a stove or sink, or may hold onto one of the handles 30, and use a single hand to work. Thus, a user 15 may access a table, workbench, sink, stove, countertop, bureau, or the like. Similarly, a user 15 can move to and rotate in alignment against any wall, furniture, appliance, or the like in order to cook, clean, retrieve, or otherwise work thereat.

Thus, one may see that a user 15 provides exercise to the legs in a standing position all day. Nevertheless, at will, a user 15 may move sideways, twist, turn, and the like in order to shift weight from one foot to another, from one leg to another, from one hip to another, and so forth. Meanwhile, a user 15 may lean forward and rest arms on one or both of the handles 30. One may actually lean forward supported by the handles 30 to operate in front of the apparatus 10.

However, it has been found a very straightforward matter to align the apparatus 10 with one side against a counter, table, or workbench, and then simply rotate the body with a hip restrained against movement toward the front of the apparatus 10 by the handle 30a, and an opposite thigh restrained by the pads 36 of the forward restraint 34. Thus, a user 15 may completely turn to face sideways out of or away from the stringers 32.

Depending on the need for support by an individual user 15, a user 15 may rely on both a hand on a handle 30, and a thigh against one of the stringers 32 in order to reach away from the apparatus 10 and toward the back of a counter or table being accessed. Thus, the core muscles in the legs and torso required for such a leaning motion sideways provide an otherwise unavailable degree of exercise for core muscles. Everything from the feet to the shoulders and hands is exercised by such a leaning motion.

A prescribed regimen of exercise produces no useful result other than the exercise itself. Such regimens are routinely prescribed by physical therapists. However, doctors, physical therapists, nurses, caregivers and the like recognize the difficulty in obtaining compliance with any such exercise regimen. With an apparatus 10 and method in accordance with the invention, the natural daily life activities of a user 15 are exercise and motivation in and of themselves. Such motions also prevent excess time and pressure on any location of the body. Thus, an apparatus 10 provides the mechanism or device enabling the daily life activity, which activity itself provides exercising.

Not to be forgotten, pressure on tissues arises from the structures of bone material capturing soft tissue against some other object, such as a seat, mattress, object, surface, or another bone. Pressure or compression of soft tissue tends to close off blood vessels of any and all sizes. In medical trauma, large arteries are subjected to pressure in order to slow flow therefrom. Whether capillary, major artery, or anything between, a blood vessel, individual cell and tissue under pressure results in constricting flow of fluids (e.g. blood).

This phenomenon gives rise to pressure sores. Sores arise because tissues inflame or die. When tissues are damaged or inflamed, the body must flood the area with blood flow in order to carry on all of the transport processes for delivering nutrition, oxygen, hydration, and the like as well as retrieving waste products. The very problem that causes limited circulation and therefore inflammation, and eventual sore development or even necrosis (cell death), also prevent the remediation of these problems.

The same compression that limits circulation and causes damage also inhibits the ability of the body to repair. Thus, providing a range of all available motion of which a user 15 is capable in an apparatus 10, no point on the body need be exposed to any amount of pressure unwanted. Even in the apparatus 10 in accordance with the invention, as illustrated, a certain amount of weight may be removed from feet by relying on the forward restraint 34, and particularly the specific orientation of the pads 36 thereof.

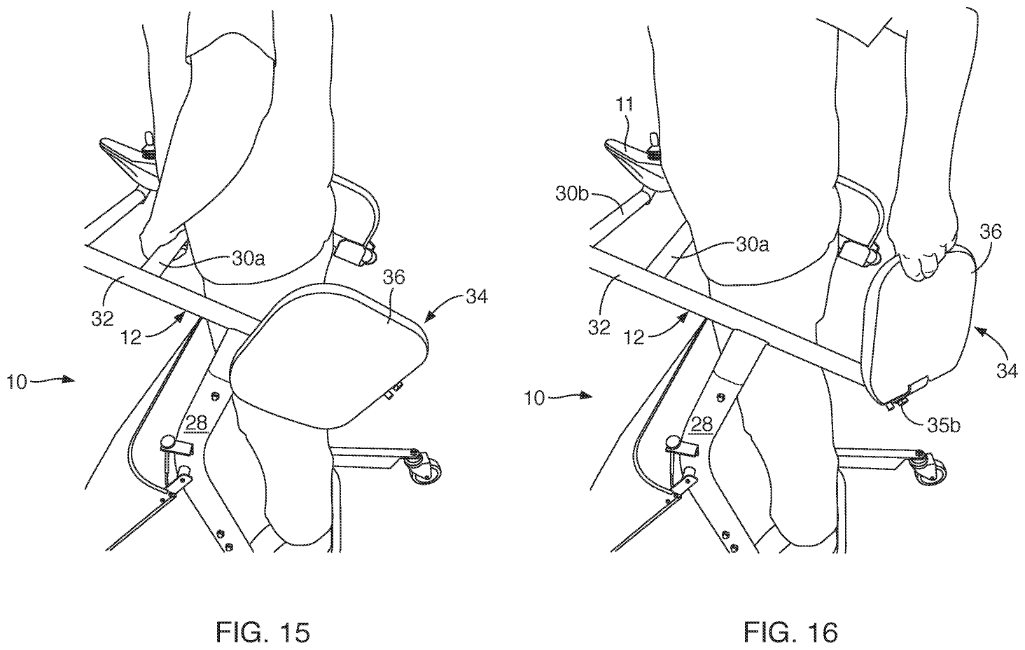

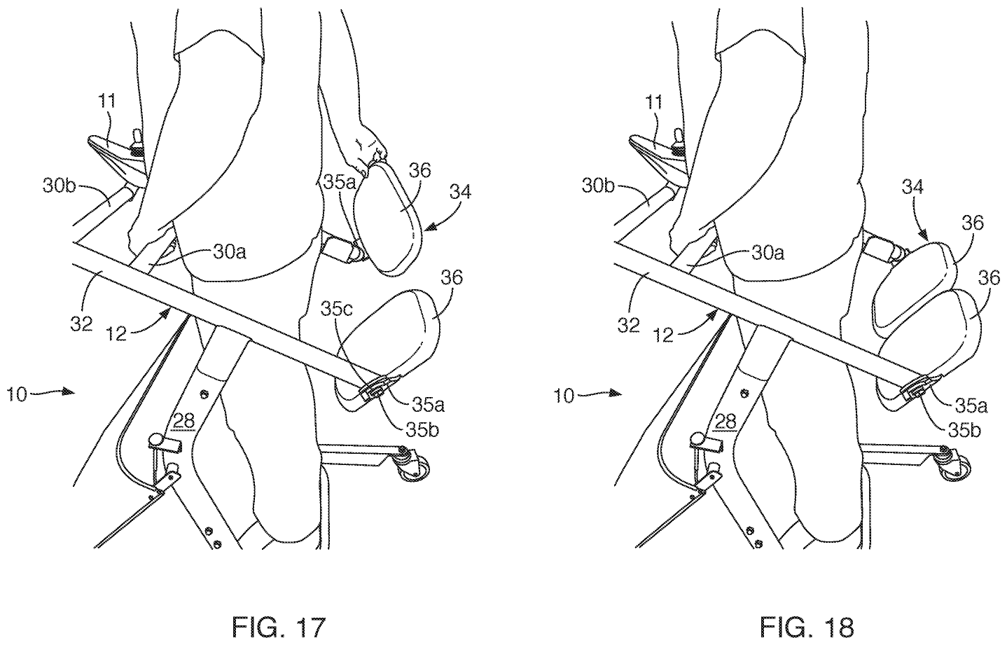

Referring to FIGS. 15 through 18, while continuing to refer generally to FIGS. 1A and 1B through 18, a pad 36 of a forward restraint 34 is illustrated in a stowed position of FIG. 15, followed by a partially deployed position 16 as the pad 36 is rotated about an ear 35a pivoting about a pivot 35b. As in the illustration of FIG. 17 demonstrates, the unique angle of the angled edge 35c of the stringer 32 requires but a single pivot to move from a stowed position parallel to the stringer 32 to a deployed position perpendicular to the stowed position.

Meanwhile, the second of the pads 36 may be similarly operated with a single hand by a user 15 to provide support of both pads 36 behind the user 15. Selection of the particular angle of the pads 36 with respect to a vertical or horizontal plane may provide a balance between the amount of forward horizontal support and vertical upward support of a user 15 leaning thereagainst. Meanwhile, at all times, a user 15 is at liberty to pull on the handles 30 in order to have a more vertical posture, or relax against the pads 36 in order to provide something closer to a seated posture.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
providing a unit comprising a base, superstructure, motor, wheels, power source, and controller operably connected to carry a user, weighting the feet of the user in a standing posture, the base defining a longitudinal direction forward and backward, a lateral direction left and right, and a transverse direction vertically, all mutually orthogonal;
drawing the user from a sitting position on the furniture to the standing posture on the base and within an enclosed region; and
moving the user, in a standing posture, at will along the surface in response to the user operating the wheels, powered by the motor, through the controller.

2. The method of claim 1, wherein:
the superstructure is provided with a forward support; and
the method comprises positioning the forward support behind the user to limit movement of the user backward with respect to the unit.

3. The method of claim 2, wherein the moving includes translating forward, translating backward, and pivoting about a vertical axis positioned at an arbitrary location with respect to the unit.

4. The method of claim 2, wherein the forward support is shaped and positioned with respect to the unit and the user to provide a degree of vertical support to the user while maintaining the majority of the weighting on the feet.

5. The method of claim 4 wherein the forward support is pivotably secured to the superstructure to pivot between a stowed position beside the user to a deployed position behind the user to urge the user forward when deployed and contacted by the user.

6. The method of claim 5, wherein:
the superstructure includes at least one handle positioned forward of the user and lateral supports positioned left and right thereof, together defining the enclosed space; and
the enclosure leaves the user free to exercise core muscles by bending left, right, backward and forward from the waist.

7. The method of claim 1, comprising:
positioning the unit proximate a furniture supported on a surface underlying it;
gripping, by the user, the superstructure defining an enclosed region; and
pulling, by the user, the body of the user into the standing posture on the base within the enclosed region.

8. The method of claim 8, wherein:
the furniture is selected from a bed, a couch, a chair, a wheelchair, and a motorized seat;
the positioning includes moving a proximal end of the base to fit in a lapping relation with the furniture in a floor space shared by both.

9. The method of claim 7, wherein:
the enclosed region comprises a forward restraint behind the user, a handle forward of the user and side supports extending rearward on the left and right thereof, respectively, together limiting lateral movement below the waist of a user thereon; and
the method includes moving forward, backward, left, and right to accomplish tasks using the hands of the user outside the enclosure.

10. The method of claim 9, wherein:
the motor comprises two drive motors, each independently controllable;
the forward restraint comprises a bracket positionable by pivoting between a stowed position beside the user and a deployed position behind the user;
the wheels comprise drive wheels and casters spaced to stabilize the base on a flat underlying surface, the drive wheels each being operably connected to be driven by a respective one of the two drive motors to rotate proximate a front, distal, end of the base.
wherein the casters are positioned to rotate on a horizontal axis and pivot about a vertical axis in response to a difference in a rate of rotation between the drive wheels; and
the base is provided with a deck to receive the feet of the user and a front brace to stabilize the legs of the user against moving too far forward with respect to the deck.

11. An apparatus comprising:
a base;
a superstructure fixed to and above the base;
drive wheels positioned to rotate about a horizontal axis proximate a front of the base;
drive motors operably connected to drive the drive wheels;
a power source operably connected to the drive motors to be controlled by a controller;
the base, comprising a deck capable of carrying a user, weighting the feet of the user in a standing posture;
the superstructure, comprising a handle capable of supporting force of a user drawing the body of the user from a sitting position, supported elsewhere, into a standing posture on the deck;
the superstructure comprising side supports restraining the user below the waist thereof against moving outside an enclosed space defined by the handle and the side supports; and
the controller positioned to be capable of operation by the user to translate the apparatus forward, backward, and pivoting left and right in response to signals input by the user in the standing posture.

12. The apparatus of claim 11, comprising a forward support positioned to provide support behind the user, limiting movement of the user backward with respect to the unit.

13. The apparatus of claim 12, wherein the forward support is shaped and positioned with respect to the unit and the user to provide a degree of vertical support to the user while maintaining the majority of the weighting on the feet.

14. The apparatus of claim 12 wherein the forward support is pivotably secured to the superstructure to pivot between a stowed position beside the user and a deployed position behind the user to urge the user forward when deployed and contacted by the user.

15. The apparatus of claim 11, wherein the enclosure is shaped to leave the user free to exercise core muscles by bending left, right, backward and forward from the waist.

16. The apparatus of claim 11, wherein the base and superstructure are together shaped to provide access to the apparatus by a user from a furniture, selected from a bed, a couch, a chair, a wheelchair, and a motorized seat by moving a proximal end of the base to fit in a lapping relation with the furniture in a floor space shared by both.

17. The apparatus of claim 11, wherein the two drive motors, are each independently controllable;
the forward restraint comprises a bracket positionable by pivoting between a stowed position beside the user and a deployed position behind the user;
the wheels comprise casters spaced to stabilize the base on a flat underlying surface, the drive wheels each being operably connected to be driven by a respective one of the two drive motors to rotate proximate a front, distal, end of the base.
the casters are positioned to rotate on a horizontal axis and pivot about a vertical axis in response to a difference in a rate of rotation between the drive wheels; and
the base comprises a deck to receive the feet of the user and the super structure includes a front brace to stabilize the legs of the user against moving too far forward with respect to the deck.
